(19) United States
(12) Patent Application Publication
(10) Pub. No.: US 2023/0219604 A1
(43) Pub. Date: Jul. 13, 2023

(54) RAILWAY POINT MANAGING SYSTEM AND METHOD

(71) Applicant: KONUX GMBH, München (DE)

(72) Inventors: Andres HERNANDEZ CANSECO, Edingen-Neckarhausen (DE); Elias Huber, Munchen (DE); Clara Happ-Kurz, Munchen (DE); Scott Muller, Berlin (DE)

(21) Appl. No.: 17/927,812

(22) PCT Filed: May 12, 2021
(86) PCT No.: PCT/EP2021/062760

§ 371 Date: Nov. 25, 2022

(30) Foreign Application Priority Data
May 26, 2020 (EP) 20176547.6

(51) Int. Cl. B61L 27/53; B61L 27/16; B61L 5/06; G06N 20/00

(52) U.S. Cl. CPC B61L 27/53; B61L 27/16; B61L 5/06; G06N 20/00

(57) ABSTRACT

The present invention relates to a system for monitoring a railway network, the system comprising at least one sensor component configured to sample sensor data relevant to the railway network, at least one processing component configured to process the sensor data, at least one storing component configured to store the sensor data relevant to the railway network and the processed sensor data, and/or at least one analyzing component. The present invention also refers to a method for monitoring a railway network, the method comprising the steps of: retrieving at least one point machine data, processing the least one point machine data to generate at least one processed point machine data, and generating at least one railway health hypothesis based on the at least one processed point machine data.

### FIELD

The invention lies in the field of failure diagnosis and particularly in the field of diagnosing failure based on electric current analysis of point machines. The goal of the invention is to provide a method for monitoring a railway system. More particularly, the present invention relates to a system for monitoring and forecasting health status of a railway network, a method performed in such a system and corresponding use of a system.

### BACKGROUND

Railroad, railway or rail transport has been developed for transferring goods and passengers on wheeled vehicles on rails, also known as tracks. In contrast to road transport, where vehicles run on a prepared flat surface, rail vehicles (rolling stock) are directionally guided by the tracks on which they run. Tracks commonly consist of steel rails, installed on ties or sleepers and ballast, on which the rolling stock, usually provided with metal wheels, moves. Other variations are also possible, such as slab track, where the rails are fastened to a concrete foundation resting on a subsurface.

Rolling stock in a rail transport system generally encounters lower frictional resistance than road vehicles, so passenger and freight cars (carriages and wagons) can be coupled into longer trains. Power is provided by locomotives, which either draw electric power from a railway electrification system or produce their own power, usually by diesel engines. Most tracks are accompanied by a signaling system. Railways are a safe land transport system when compared to other forms of transport. Additionally, railways are capable of high levels of passenger and cargo utilization and energy efficiency but are often less flexible and more capital-intensive than road transport, when lower traffic levels are considered.

The inspection of railway equipment is essential for the safe movement of trains. Many types of defect detectors are in use today. These devices utilize technologies that vary from a simplistic paddle and switch to infrared and laser scanning, and even ultrasonic audio analysis. Their use has avoided many rail accidents over the past decades.

Railway operations require careful monitoring and control of the conditions of the railway infrastructure to ensure passenger safety and reliable service. Many sensors are used to monitor and obtain data from different infrastructural component of the railway network, which may be used to ensure the integrity of the service and identify possible sources of malfunction. Such sensors allow for data collection and analysis and ensure safer operations of railways. Various sensors can be placed directly on trains, on tracks or nearby, at train stations and/or on platforms, and generally in the overall vicinity of the railway.

Measurements of such sensors may be used to further measurements, control, prediction and optimization of operation of railways.

Veerababu et al. discloses that track circuit ascertains the occupancy/clearance of a track section in Indian Railways. Point is required to divert train from one track to other. Track and Point Health Monitoring unit is a micro controller based wireless system which provides the information about point and track circuit. The system gives the currents and voltages taken by DC motor and the leakages between feed end and relay ends by measuring the voltages and currents across the ends. The record of Track parameters over a period of time can be useful for monitoring the deterioration of track behavior like increased leakages over time line. The record of Point parameters over a period of time can be useful for monitoring the deterioration of various parts of the point machine and also dry slide chairs of the point over time line. This monitoring reduces the MTTR and increases the MTBF which is cost effective for the railways.

Li et al. refers to a data-driven fault diagnosis, which is considered a modern technique in Industry 4.0. In the area of urban rail transit, researchers focus on the fault diagnosis of railway point machines as failures of the point machine may cause serious accidents, such as the derailment of a train, leading to significant personnel and property loss. This paper presents a novel data driven fault diagnosis scheme for railway point machines using current signals. Different from any handcrafted feature extraction approach, the proposed scheme employs a locally connected autoencoder to automatically capture high-order features. To enhance the temporal characteristic, the current signals are segmented and blended into some subsequences. These subsequences are then fed to the proposed autoencoder. With the help of a weighting strategy, the seized features are weight averaged into a final representation. At last, different from the existing classification methods, we employ the local outlier factor algorithm to solve the fault diagnosis problem without any training steps, as the accurate data labels that indicate a healthy or unhealthy state are difficult to acquire. To verify the effectiveness of the proposed fault diagnosis scheme, a fault dataset termed “Cu-3300” is created by collecting 3300 in-field current signals. Using Cu-3300, the authors allegedly performed comprehensive analysis to demonstrate that the proposed scheme outperforms the existing methods. They have made the dataset Cu-3300 and the code file freely accessible as open source files. To the best of their knowledge, the dataset Cu-3300 is the first open source dataset in the area of railway point machines and our conducted research is the first to investigate the use of autoencoders for fault diagnosis of point machines.

### SUMMARY

In light of the above, it is therefore an object of the present invention to overcome or at least to alleviated the shortcomings and disadvantages of the prior art. More particularly, it is an object of the present invention to provide a method and a corresponding system for monitoring the health status of railway network.

These objects are met by the present invention.

In a first aspect, the present invention relates to a system for monitoring a railway network, the system comprising: at least one sensor component configured to sample sensor data relevant to the railway network, at least one processing component configured to process the sensor data, at least one storing component configured to store the sensor data relevant to the railway network and the processed sensor data, and/or at least one analyzing component. Such a system may be particularly advantageous, as it may allow to monitor a railway network, which is beneficial as it may further permit diagnosing a plurality of health status and forecasting the railway network performance, which may, for instance, comprise failure of components of the railway network.

In one embodiment, the at least one analyzing component may be configured to at least one of: receive the sensor data from the at least one sensor component, monitor at least one railway health status of at least one component of the railway network, forecast at least one railway health status of at least one component of the railway network, and/or generate at least one railway health status hypothesis comprising at least one cause for the at least one railway health status of the at least one component of the railway network.

Furthermore, the at least one sensor component may comprise at least one sensor node.

In one embodiment, the sensor data relevant to the railway network may comprise at least one railway infrastructural feature.

Moreover, the at least one railway infrastructural feature may comprise at least one feature based on electric current (EC) records. E.g. sudden or gradual changes in overall level or rate of the features over time.

In a further embodiment, the at least one analyzing component may comprise a self-learning module, wherein the self-learning module may be configured to at least one of: analyze the at least one infrastructural feature, determine changes of the at least one infrastructural feature over time, and/or correlate changes of the at least one infrastructural feature with at least one railway health status hypothesis.

In one embodiment, the self-learning module, in the step of correlating changes of the last one infrastructural feature with at least one railway health status hypothesis, may further be configured to execute at least one simulation model.

The at least one sensor node at least one computing module.

The at least one computing module may be a remote computing module.

In one embodiment, the at least one analyzing component may be configured to execute at least one analytical approach. Such at least one analytical approach may, for instance, but not limited to, comprise at least one of signal filter processing, pattern recognition, probabilistic modeling, Bayesian schemes, machine learning, supervised learning, unsupervised learning, reinforcement learning, statistical analytics, statistical models, principle component analysis, independent component analysis (ICA), dynamic time warping, maximum likelihood estimates, modeling, estimating, neural network, convolutional network, deep convolutional network, deep learning, ultra-deep learning, genetic algorithms, Markov models, and/or hidden Markov models.

In one embodiment, the system further may comprise at least one server, which may be configured to at least one of: receive sensor data relevant to the railway network, monitor the sensor data, and/or generate an optimizing routing of rolling stocks on the railway network based on sensor data related to the railway network, wherein the at least one server may be configured to generate an optimizing routing of rolling stocks by means of the least one analytical approach.

In another embodiment, the system may be arranged comprising an association of at least one of: a sensor component with at least one rolling stock, and/or a sensor component with at least one railway infrastructure.

In a further embodiment, the at least one server may be configured to provide at least one signal comprising: sensor data, optimizing routing, and/or at least one railway infrastructural data, wherein the at least one signal may be processed based on at least one analytical approach.

Moreover, the at least one sensor may be configured to operate in a plurality of operation modes, and wherein each operation mode may be configured to monitor at least one sensor data relevant to railway network.

In another embodiment, the at least one server may comprise an interface module configured to bidirectionally communicate with at least one authorized user.

In a further embodiment, the at least one server may be configured to at least one of: monitor traffic of rolling stocks in railway networks, and/or forecast health status of the at least one railway network based on the at least one infrastructural feature.

The at least one storing component may be configured to store all data generated by the at least one server.

The at least one sensor node may be arranged on at least one railway infrastructure.

The at least one railway infrastructure may comprise at least one unmovable infrastructure, such as railway tracks.

The at least one railway infrastructure may comprise at least one movable infrastructure.

The at least one movable infrastructure may comprise translational movability along and/or on at least one unmovable infrastructure, such wheels, bogies, wagons.

The at least one movable infrastructure may comprise limited mobility, such as point machine, railway switches.

The at least one sensor component may comprise at least one of: pressure sensor, accelerometer, inclinometer, thermal sensor, acoustic sensor, and/or visual sensor.

In another embodiment, the system may comprise a base station.

In one embodiment, the sensor node may be configured to transmit sensor data to the base station, which may be configured to retrieve sensor data from the at least one sensor node.

In another embodiment, the base station may be configured to retrieve sensor data from the at least one sensor node arranged within a distance to the base station, wherein the distance may be between 0.5 m and 50 Km, preferably between 1 and 20 Km, more preferably between 5 m and 10 Km, such as at 1 Km.

In a further embodiment, the base station may further be configured to bidirectionally communicate to the at least one server.

The at least one sensor node may be configured to bidirectionally exchange data with the at least one server.

The base station may comprise at least one of CAN, Flex Ray, Wi-Fi, Bluetooth, ZigBee, GPRS, EDGE, UMTS, LTE, fiber optics.

In one embodiment, the at least one server may be a remote server.

In another embodiment, the at least one server may comprise at least one long-range communication component, such as GPRS, EDGE, UMTS, LTE and/or satellite.

In one embodiment, the processing component may be configured to collect sensor data from the at least one of: at least one sensor node, base station, and/or at least one server.

In another embodiment, the processing component may be configured to generate structured database using the sensor data.

In a further embodiment, the processing component may be configured to execute at least one analytical approach.

The analyzing component may be configured to execute at least one analytical approach.

In one embodiment, at least one of: the processing component, and/or the analyzing component may be arranged in the server.

The system may be configured to execute at least one machine learning algorithms, which may, for example, comprise pattern recognition.

The at least one processing component may be configured to (automatically) perform signal processing.

In a second aspect, the present invention relates to a method for monitoring a railway network, the method comprising the steps of: retrieving at least one point machine data, processing the least one point machine data to generate at least one processed point machine data; and generating at least one railway health hypothesis based on the at least one processed point machine data.

In one embodiment, the method may further comprise the step of forecasting at least one railway health status of at least one component of the railway network based on the at least one railway health hypothesis.

Such an approach may be particularly advantageous, as it may allow to forecast at least one health status of at least one component of the railway network, for instance, of at least one point machine.

In one embodiment, the step of forecasting at least one railway health status of the at least one component the railway network may comprise using trends in at least one feature based on electric current (EC) records.

In one embodiment, the one railway health hypothesis may comprise at least one point machine health data, which may be particularly advantageous as a point machine and may comprise a plurality of electrical and physical components, of which each may be subjected to a plurality of potential issues. For instance, failure of any of these components could constitute a point machine failure and thus to a poor point machine health. Therefore, maintenance reports should identify a failure mode and potentially also identify which component may have been responsible for (potential) failures.

Moreover, further advantages may derive from decomposing point machine health status into a plurality of health status of its components such as motor, driving rod, locking mechanism, which may also be beneficial as it may allow to even determine sub-health values and aggregate them to a point machine health status.

In another embodiment, the method may further comprise the step of generating at least one railway failure hypothesis.

In one embodiment, the at least one railway failure hypothesis may be based of the at least one railway health hypothesis.

In another embodiment, the at least railway failure hypothesis may be based on the at least one processed point machine data.

The at least one failure hypothesis may be based on the at least one point machine data.

In a further embodiment, the method further may comprise the step of forecasting at least one railway failure of at least one component of the railway network based on the at least one railway failure hypothesis.

Such an approach may be particularly advantageous, as it may allow to forecast at least one railway failure, which may be beneficial as it may allow improving maintenance and/or inspection planification, which may further be advantageous to minimize downtime of, for example, single machines and/or adjacent railway networks.

The at least one component of the railway network may comprise at least one point machine. This may be particularly advantageous, as it may be useful to incorporate addition physical data into, for example, a machine learning model, data which may comprise, inter alia, (live) EC data, blade strain, blade contact in locking, data from sensors in field, etc.

The at least one component of the railway network may comprise weighted averages.

The method may comprise using statistical summaries comprising at least one of: time length of trace, maximal/minimum values, several quantiles, variance, mean, statistical features on phase-splits parts of trace, and/or weighted averages.

The method further may comprise using at least one feature based on at least one transformation of traces.

In one embodiment, the at least one transformation of traces may comprise at least one traces as function of time, wherein the at least one trace as function of time may comprise at least one of: electric current, power, resistance, hydraulic force, and/or pneumatic force.

In another embodiment, the at least one transformation of traces may comprise at least one of: functional principal component analysis scores, reductions of wavelet transformation, and/or deviations from at least one average curve.

The method may comprise using at least one variational auto encoder for the reduction of wavelet transformation.

Furthermore, the method comprising the step of calculating at least one feature based on at least one complete trace.

In one embodiment, the method may further comprise the step of calculating at least one feature based on at least one specific part of at least one trace.

In a further embodiment, the method may further comprise the step of splitting the at least one trace into at least one time interval, which may comprise equal-length time intervals.

In one embodiment, the at least one time interval may comprise at least 100 ms of data, preferably at least 1 s of data, more preferably at least 3 s of data, such as 5.5 s of data.

In another embodiment, the at least one time interval may comprise not greater than 60 s, preferably not greater than 30, more preferably not greater than 15 s.

Moreover, the method may further comprise the step of splitting the least one trace into at least one phase, which may comprise a ramp-up phase, an unlocking phase.

In another embodiment, the at least one phase may comprise a moving phase, wherein the moving phase may comprise at least one of: moving a first blade, and/or moving a second blade.

Furthermore, the at least one phase may comprise locking phase.

The at least one feature may be used directly.

In one embodiment, the method may comprise using the at least one feature aggregating the at least one feature over at least one time window, which may comprise a continuous time window, an hourly window, a daily window, a weekly window, a monthly window, a yearly window and/or any combination thereof.

In another embodiment, the at least features aggregates over time comprising at least one of: a minimum feature value, a maximum feature value, a mean feature value, a sum feature value, a variance, a standard deviation, coefficients of univariate regression of different orders, and/or ratio between aggregation value of different parts of the least one time window.

Moreover, the at least one time window may comprise at least one of: quantiles, and/or weighted averages.

In one embodiment, the step of forecasting at least one railway health status of the at least one component the railway network may comprise using trends in at least one feature not based on electric current (EC) records, which may comprise at least one of: air temperature, rail temperature, position of blades, model of point machine, and/or position of point machine.

Moreover, the method may further comprise the step of generating at least one hypothesis as regards the position of blades, wherein the method comprises: outputting a first finding comprising a first position of the blades, outputting a second finding comprising a second position of the blades, contrasting the first finding with the second finding, and/or generating a cause for the difference between the first finding and second finding.

In one embodiment, the first position of the blades may be a left locking position and the second position of the blades may be a right blocking position.

In another embodiment, the first position of the blades may be different from the second position of the blades.

In a further embodiment, the first position of the blades may be equal to the second position of the blades.

Moreover, the step of forecasting at least one railway health status of the at least one component the railway network may comprise using trends in at least one feature comprising at least one of: vertical acceleration, vertical displacement, tonnage, load, stress on the railway network over time, lateral acceleration, lateral displacement, and/or tilt.

In another embodiment, the step of forecasting at least one railway health status of the at least one component the railway network such as frog, blade, track bed.

In a further embodiment, the step of forecasting at least one railway health status of the least one component of the railway network may be based on at least one analytical approach.

Furthermore, the method may comprise using at least one supervised learning method, which may be based on at least one of: random forests, and/or at least one regression and classification approach.

In another embodiment, the method may comprise using at least one unsupervised learning method, which may be based on at least one of: anomaly detection, clustering, and/or time series forecasting.

The method may further comprise the step of generating at least one true label for the at least one supervised learning method, which may comprise using at least one recorded data relevant to at least on railway network.

The at least one recorded data may comprise at least one of: inspection data, maintenance data, delay data, rerouting data, and/or other monitoring systems.

In another embodiment, the step of generating at least one true label for the at least one supervised learning method may comprise annotating the at least one recorded data relevant to at least one railway network, wherein annotating the last one recorded data may comprise identifying at least one outlier data. This may be particularly advantageous, as it may allow to formed label classes based on reliable acquired ground truth data, which may be beneficial as the nature of these may be dependent on decisions that may be made on failure modes.

For instance, to construct the at least one true label, it may be possible to use, but not limited to, inspection, maintenance, delay, rerouting information recorded by the railway track service companies, or other detected outliers in a plurality of data, such as extremely long or very anomalous looking EC traces. Furthermore, this may also allow to look for “retries”, i.e. if a second attempt to move, for example, a component from one position to another, such as from left to right or vice versa, after already recording an (attempted) movement in that direction and this may then be interpreted, for instance, as a failure.

Moreover, the method may further comprise the step of: retrieving a first data of a first occurrence of a feature, processing the first data of the first occurrence of the feature, retrieving a second data of a second occurrence of the feature, processing the second data of the second occurrence of the feature, generating a data difference finding, wherein the data difference finding may be based on at least one parameter difference between the first data of the first occurrence and the second data of the second occurrence, and outputting an interpreted data difference finding.

In another embodiment, the method may further comprise the step of: retrieving a first data of a first occurrence of a feature, processing the first data of the first occurrence of the feature, retrieving a n-th data of a n-th occurrence of the feature, processing the n-th data of the n-th occurrence of the feature, generating a data difference finding, wherein the data difference finding may be based on at least one parameter difference between the first data of the first occurrence and the n-th data of the n-th occurrence, and outputting an interpreted data difference finding.

In one embodiment, the at least one parameter difference may comprise at least difference comprising at least one feature of: maximum within an area, minimum within an area, maximum/minimum within a dynamically determined area, mean within an area, principal component level, and/or excursions beyond an envelope.

The present invention relates to the use of the system for carrying out the method according as recited herein.

In another embodiment, the present invention also relates to the use of the method as and the system as recited herein for monitoring a railway network.

In a further embodiment, the present invention relates to the use of the method and the system as recited herein for generating at least one railway health hypothesis.

Moreover, the present invention relates to the use of the method according and the system as recited herein for forecasting at least one railway health status of at least one component of the railway network.

Furthermore, the present invention relates to the use of the method and the system as recited herein for forecasting at least one feature of at least one component of the railway network.

The present invention also relates to a computer-implemented program comprising instructions which, when executed by a user-device, causes the user-device to carry out the method steps as recited herein.

Moreover, the present invention relates to a computer-implement program comprising instructions which, when executed by a server, causes the server to carry out the method as recited herein.

In one embodiment, the present invention relates to a computer-implement program comprising instructions which, when executed causes by a user-device, causes the user-device and a server to carry out the method as recited herein.

In another embodiment, the present invention relates to a computer-implement program comprising instructions which, when executed causes by a server, causes a user-device and the server to carry out the method as recited herein.

In simple terms, the object of the present invention is to disclose a system and a method to predict railway health, preferably using the current in the point machine. Furthermore, the approach of the present invention may allow to both the monitoring and the prediction by means of using trends in features based on the Electric Current (EC) records, which may allow to identify outliers in advance.

Furthermore, the present invention may also allow to monitor and/or predict the health status using data not based on EC traces, which can be used for the point machine health monitoring and prediction. A similar method could possibly be applied to other point machine measurements besides EC or non-EC, for example, by a force applied to a driving rod, voltage, etc.

A reliable forecasting of failures in the point machine may be particularly advantageous, as it may allow to avoid and/or at least reduce broken and/or not working point machines, as such defective components that may lead directly to a complete shutdown of a railway network. As such, forecasting of point machine can be particularly beneficial both in financial and safety terms, as it may allow to adjust routings of the inspection and maintenance and as such failures. E.g. breaking, of the point machine can either be prevented or fixed more efficiently.

The present technology is also defined by the following numbered embodiments.

Below, system embodiments will be discussed. These embodiments are abbreviated by the letter “S” followed by a number. When reference is herein made to a system embodiment, those embodiments are meant.

S1. A system for monitoring a railway network, the system comprising
at least one sensor component configured to sample sensor data relevant to the railway network,
at least one processing component configured to process the sensor data,
at least one storing component configured to store the sensor data relevant to the railway network and the processed sensor data, and
at least one analyzing component.

S2. The system according to the preceding embodiment, wherein the at least one analyzing component is configured to at least one of
receive the sensor data from the at least one sensor component,
monitor at least one railway health status of at least one component of the railway network,
forecast at least one railway health status of at least one component of the railway network, and/or
generate at least one railway health status hypothesis comprising at least one cause for the at least one railway health status of the at least one component of the railway network.

S3. The system according to any of the 2 preceding embodiments, wherein the at least one sensor component comprises at least one sensor node.

S4. The method according any of the preceding embodiments, wherein the sensor data relevant to the railway network comprises at least one railway infrastructural feature.

S5. The system according to the preceding embodiments, wherein the at least one railway infrastructural feature comprises at least one feature based on electric current (EC) records.

S6. The system according to any of the preceding embodiments and with features of embodiment S4 or S5, wherein the at least one analyzing component comprises a self-learning module, wherein the self-learning module is configured to at least one of
analyze the at least one infrastructural feature,
determine changes of the at least one infrastructural feature over time, and/or
correlate changes of the at least one infrastructural feature with at least one railway health status hypothesis.

S7. The system according to the preceding embodiment, wherein self-learning module, in the step of correlating changes of the last one infrastructural feature with at least one railway health status hypothesis, is further configured to execute at least one simulation model.

S8. The system according to any of the preceding embodiments and with features of embodiment S3, wherein the at least one sensor node comprises at least one computing module.

S9. The system according to the preceding embodiment, wherein the at least one computing module is a remote computing module.

S10. The system according to any of the preceding embodiments, wherein the at least one analyzing component is configured to execute at least one analytical approach.

S11. The system according to any of the preceding embodiments, wherein the system further comprises at least one server.

S12. The system according to the 2 preceding embodiments, wherein the at least one server is configured to at least one of
receive sensor data relevant to the railway network,
monitor the sensor data, and/or
generate an optimizing routing of rolling stocks on the railway network based on sensor data related to the railway network, wherein the at least one server is configured to generate an optimizing routing of rolling stocks by means of the least one analytical approach.

S13. The system according to any of the preceding embodiments, wherein the system is arranged comprising an association of at least one of
a sensor component with at least one rolling stock, and/or
a sensor component with at least one railway infrastructure.

S14. The system according to any of the preceding embodiments, wherein the at least one server is configured to provide at least one signal comprising
sensor data,
optimizing routing, and/or
at least one railway infrastructural data,

wherein the at least one signal is processed based on at least one analytical approach.

S15. The system according to any of the preceding embodiments, wherein the at least one sensor is configured to operate in a plurality of operation modes, and wherein each operation mode is configured to monitor at least one sensor data relevant to railway network.

S16. The system according to any of the preceding embodiments, wherein the at least one server comprises an interface module configured to bidirectionally communicate with at least one authorized user.

S17. The system according to any of the preceding embodiments, wherein the at least one server is configured to at least one of
monitor traffic of rolling stocks in railway networks, and/or
forecast health status of the at least one railway network based on the at least one infrastructural feature.

S18. The system according to any of the preceding embodiments, wherein the at least one storing component is configured to store all data generated by the at least one server.

S19. The system according to any of the preceding embodiments and features of embodiment S3 or S13, wherein the at least one sensor node is arranged on at least one railway infrastructure.

S20. The system according to the preceding embodiment, wherein the at least one railway infrastructure comprises at least one unmovable infrastructure, such as railway tracks.

S21. The system according to any of the 2 preceding embodiments, wherein the at least one railway infrastructure comprises at least one movable infrastructure such as point machines, railway switches, frogs, rail barriers.

S22. The system according to any of the 3 preceding embodiments and with features of embodiments S12 or S13, wherein the at least one sensor is arranged on at least one rolling stock and/or at least one component of rolling stocks, such as wheels, bogies, wagons.

S23. The system according to any of the preceding embodiments, wherein the at least one sensor component may comprise at least one of:
pressure sensor,
accelerometer,
inclinometer,
thermal sensor,
acoustic sensor, and/or
visual sensor.

S24. The system according to any of the preceding embodiments, wherein the system comprises a base station.

S25. The system according to any of the preceding embodiments, wherein the sensor node is configured to transmit sensor data to the base station.

S26. The system according to any of the preceding embodiments, wherein the base station is configured to retrieve sensor data from the at least one sensor node.

S27. The system according to any of the preceding embodiments and with features of S3 and S23, wherein the base station is configured to retrieve sensor data from the at least one sensor node arrange withing a distance to the base station, wherein the distance is between 0.5 m and 50 Km, preferably between 1 and 20 Km, more preferably between 5 m and 10 Km, such as at 1 Km.

S28. The system according to any of the preceding embodiments, wherein the base station is further configured to bidirectionally communicate to the at least one server.

S29. The system according to any of the preceding embodiments, wherein the at least one sensor node is configured to bidirectionally exchange data with the at least one server.

S30. The system according to any of the preceding embodiments, wherein the base station comprises at least one of CAN, Flex Ray, Wi-Fi, Bluetooth, ZigBee, GPRS, EDGE, UMTS, LTE, fiber optics.

S31. The system according to any of the preceding embodiments and with feature of embodiment S11, wherein the at least one server is a remote server.

S32. The system according to any of the preceding embodiments and with features of embodiment S11, wherein the at least one server comprises at least one long-range communication component, such as GPRS, EDGE, UMTS, LTE and/or satellite.

S33. The system according to any of the preceding embodiments and with features of embodiments S3 and S23, wherein the processing component is configured to collect sensor data from the at least one of
at least one sensor node,
base station, and/or
at least one server.

S34. The system according to any of the preceding embodiments, wherein the processing component is configured to generate structured database using the sensor data.

S35. The system according to any of the preceding embodiments, wherein the processing component is configured to execute at least one analytical approach.

S36. The system according to of the preceding system embodiments, wherein the analyzing component is configured to execute at least one analytical approach.

S37. The system according to any of the 2 preceding embodiments, wherein at least one of
the processing component, and/or
the analyzing component is arranged in the server.

S38. The system according to any of the 3 preceding embodiments, wherein the system is configured to execute at least one machine learning algorithms.

S39. The system according to the preceding embodiment, wherein the at least one machine learning comprises pattern recognition.

S40. The system according to any of the preceding embodiments, wherein the at least one processing component is configured to (automatically) perform signal processing

Below, method embodiments will be discussed. These embodiments are abbreviated by the letter “M” followed by a number. When reference is herein made to a method embodiment, those embodiments are meant.

M1. A method for monitoring a railway network, the method comprising the steps of retrieving at least one point machine data;
processing the least one point machine data to generate at least one processed point machine data; and
generating at least one railway health hypothesis based on the at least one processed point machine data.

M2. The method according to the preceding embodiment, further comprising the step of forecasting at least one railway health status of at least one component of the railway network based on the at least one railway health hypothesis.

M3. The method according to the preceding embodiment, wherein the step of forecasting at least one railway health status of the at least one component the railway network comprises using trends in at least one feature based on electric current (EC) records.

M4. The method according to any of the 2 preceding embodiments, wherein the one railway health hypothesis comprises at least one point machine health data.

M5. The method according to any of the preceding method embodiments, further comprising the step of generating at least one railway failure hypothesis.

M6. The method according to the preceding embodiment, wherein the at least one railway failure hypothesis is based on the at least one railway health hypothesis.

M7. The method according to any of the 2 preceding embodiments, wherein the at least one railway failure hypothesis is based on the at least one processed point machine data.

M8. The method according to any of the 3 preceding embodiments wherein the at least one failure hypothesis is based on the at least one point machine data.

M9. The method according to any of the 4 preceding embodiments, further comprising the step of forecasting at least one railway failure of at least one component of the railway network based on the at least one railway failure hypothesis.

M10. The method according to any of the preceding method embodiments, wherein the at least one component of the railway network comprises at least one point machine.

M11. The method according to any of the preceding method embodiments, wherein the method comprises using statistical summaries comprising at least one of
time length of trace,
maximal/minimum values,
several quantiles,
variance,
mean,
statistical features on phase-splits parts of trace, and/or
weighted averages.

M12. The method according to any of the preceding method embodiments, wherein the method further comprises using at least one feature based on at least one transformation of traces.

M13. The method according to the preceding embodiment, wherein the at least one transformation of traces comprises at least one traces as function of time, wherein the at least one trace as function of time comprises at least one of
electric current,
power,
resistance,
hydraulic force, and/or
pneumatic force.

M14. The method according to the preceding embodiment, wherein the at least one transformation of traces comprises at least one of
functional principal component analysis scores,
reductions of wavelet transformation, and/or
deviations from at least one average curve.

M15. The method according to the preceding embodiment, wherein the method comprises using at least one variational auto encoder for the reduction of wavelet transformation.

M16. The method according to any of the preceding method embodiments, further comprising the step of calculating at least one feature based on at least one complete trace.

M17. The method according to any of the preceding method embodiments, further comprising the step of calculating at least one feature based on at least one specific part of at least one trace.

M18. The method according to any of the preceding method embodiments, further comprising the step of splitting the at least one trace into at least one time interval.

M19. The method according to the preceding embodiment, wherein the at least one time interval comprises equal-length time intervals.

M20. The method according to the preceding embodiment, wherein the at least one time interval comprises at least 100 ms of data, preferably at least 1 s of data, more preferably at least 3 s of data, such as 5.5 s of data.

M21. The method according to any of the 2 preceding embodiments, wherein the at least one time interval comprises a time interval not greater than 60 s, preferably not greater than 30, more preferably not greater than 15 s.

M22. The method according to any of the preceding method embodiments, further comprising the step of splitting the least one trace into at least one phase.

M23. The method according to the preceding embodiment, wherein the at least one phase comprises a ramp-up phase.

M24. The method according to any of the 2 preceding embodiments, wherein the at least one phase comprises an unlocking phase.

M25. The method according to any of the 3 preceding embodiments, wherein the at least one phase comprises a moving phase, wherein the moving phase comprises at least one of
moving a first blade, and/or
moving a second blade.

M26. The method according to any of the 4 preceding embodiments, wherein the at least one phase comprises locking phase.

M27. The method according to any of the preceding method embodiments and with features of embodiment M17, wherein the at least one feature is used directly.

M28. The method according to any of the preceding method embodiments and with features of embodiment M17, wherein the method comprises using the at least one feature aggregating the at least one feature over at least one time window.

M29. The method according to the preceding embodiment, wherein the at least one time window comprises a continuous time window, an hourly window, a daily window, a weekly window, a monthly window, a yearly window and/or any combination thereof.

M30. The method according to any of the 2 preceding embodiments, wherein the at least features aggregates over time comprising at least one of
a minimum feature value,
a maximum feature value,
a mean feature value,
a sum feature value,
a variance,
a standard deviation,
quantiles,
weighted averages,
coefficients of univariate regression of different orders, and/or
ratio between aggregation value of different parts of the least one time window.

M31. The method according to any of the preceding method embodiments and with features of embodiments M2, wherein the step of forecasting at least one railway health status of the at least one component the railway network comprises using trends in at least one feature not based on electric current (EC) records.

M32. The method according to the preceding embodiment, wherein the at least one feature not based on electric current (EC) records comprises at least one of
air temperature,
rail temperature,
position of blades,
model of point machine, and/or
position of point machine.

M33. The method according to the preceding embodiment, further comprising the step of generating at least one hypothesis as regards the position of blades, wherein the method comprises
outputting a first finding comprising a first position of the blades,
outputting a second finding comprising a second position of the blades,
contrasting the first finding with the second finding, and/or
generating a cause for the difference between the first finding and second finding.

M34. The method according to preceding embodiment, wherein the first position of the blades is a left locking position and the second position of the blades is a right blocking position.

M35. The method according to any of the 2 preceding embodiments, wherein the first position of the blades is different from the second position of the blades.

M36. The method according to any of the embodiments M29 and M30, wherein the first position of the blades is equal to the second position of the blades.

M37. The method according to any of the preceding method embodiments and with features of embodiment M2, wherein the step of forecasting at least one railway health status of the at least one component the railway network comprises using trends in at least one feature comprising at least one of
vertical acceleration
vertical displacement,
tonnage,
load,
stress on the railway network over time,
lateral acceleration,
lateral displacement, and/or
tilt.

M38. The method according to any of the preceding method embodiments and with features of embodiment M2, wherein the step of forecasting at least one railway health status of the at least one component of the railway network such as a frog, blade, track bed.

M39. The method according to any of the preceding method embodiments and with features of embodiments M2, wherein the step of forecasting at least one railway health status of the least one component of the railway network is based on at least one analytical approach.

M40. The method according to the preceding embodiment, wherein the method comprises using at least one supervised learning method.

M41. The method according to any of the 2 preceding embodiments, wherein the method comprises using at least one unsupervised learning method.

M42. The method according to the preceding embodiment, wherein the at least one unsupervised learning method is based on at least one of
anomaly detection,
clustering, and/or
time series forecasting.

M43. The method according to any of the 3 preceding embodiments and with feature of embodiment M40, wherein the at least one supervised learning method is based on at least one of
random forests, and/or at least one regression and classification approach.

M44. The method according to the preceding embodiment and with feature of embodiment M40, further comprising the step of generating at least one true label for the at least one supervised learning method.

M45. The method according to the preceding embodiment, wherein the step of generating at least one true label for the at least one supervised learning method comprises using at least one recorded data relevant to at least on railway network.

M46. The method according to the preceding embodiment, wherein the at least one recorded data comprises at least one of
inspection data,
maintenance data,
delay data,
rerouting data, and/or
other monitoring systems.

M47. The method according to any of the 2 preceding embodiments, wherein the step of generating at least one true label for the at least one supervised learning method comprises annotating the at least one recorded data relevant to at least one railway network, wherein annotating the last one recorded data comprises identifying at least one outlier data.

M48. The method according to any of the preceding method embodiments and with features of embodiments M3 or M31, further comprising the step of
retrieving a first data of a first occurrence of a feature,
processing the first data of the first occurrence of the feature,
retrieving a second data of a second occurrence of the feature,
processing the second data of the second occurrence of the feature,
generating a data difference finding, wherein the data difference finding is based on at least one parameter difference between the first data of the first occurrence and the second data of the second occurrence, and
outputting an interpreted data difference finding.

M49. The method according to any of the preceding method embodiments and with features of embodiments M3 or M31, further comprising the step of
retrieving a first data of a first occurrence of a feature,
processing the first data of the first occurrence of the feature,
retrieving a n-th data of a n-th occurrence of the feature,
processing the n-th data of the n-th occurrence of the feature,
generating a data difference finding, wherein the data difference finding is based on at least one parameter difference between the first data of the first occurrence and the n-th data of the n-th occurrence, and
outputting an interpreted data difference finding.

M50. The method according to any of the 2 preceding embodiments, wherein the at least one parameter difference comprises at least a difference comprising at least one feature of
maximum within an area
minimum within an area
maximum/minimum within a dynamically determined area
mean within an area
principal component level, and/or
excursions beyond an envelope.

Below, use embodiments will be discussed. These embodiments are abbreviated by the letter “U” followed by a number. Whenever reference is herein made to “use embodiments”, these embodiments are meant.

U1. Use of the system according to any of the preceding embodiments for carrying out the method according to any of the preceding method embodiments.

U2. Use of the method according to any of the preceding method embodiments and the system according to any of the preceding embodiments for monitoring a railway network.

U3. Use of the method according to any of the preceding method embodiments and the system according to any of the preceding embodiments for generating at least one railway health hypothesis.

U3. Use of the method according to any of the preceding method embodiments and the system according to any of the preceding embodiments for forecasting at least one railway health status of at least one component of the railway network.

U4. Use of the method according to any of the preceding method embodiments and the system according to any of the preceding embodiments for forecasting at least one feature of at least one component of the railway network.

Below, program embodiments will be discussed. These embodiments are abbreviated by the letter “C” followed by a number. Whenever reference is herein made to “program embodiments”, these embodiments are meant.

C1. A computer-implemented program comprising instructions which, when executed by a user-device, causes the user-device to carry out the method steps according to any of the preceding method embodiments.

C2. A computer-implement program comprising instructions which, when executed by a server, causes the server to carry out the method steps according to any of the preceding method embodiments.

C3. A computer-implement program comprising instructions which, when executed causes by a user-device, causes the user-device and a server to carry out the method steps according to any of the preceding method embodiments.

C4. A computer-implement program comprising instructions which, when executed causes by a server, causes a user-device and the server to carry out the method steps according to any of the preceding method embodiments.

The present invention will now be described with reference to the accompanying drawings which illustrate embodiments of the invention. These embodiments should only exemplify, but not limit, the present invention.

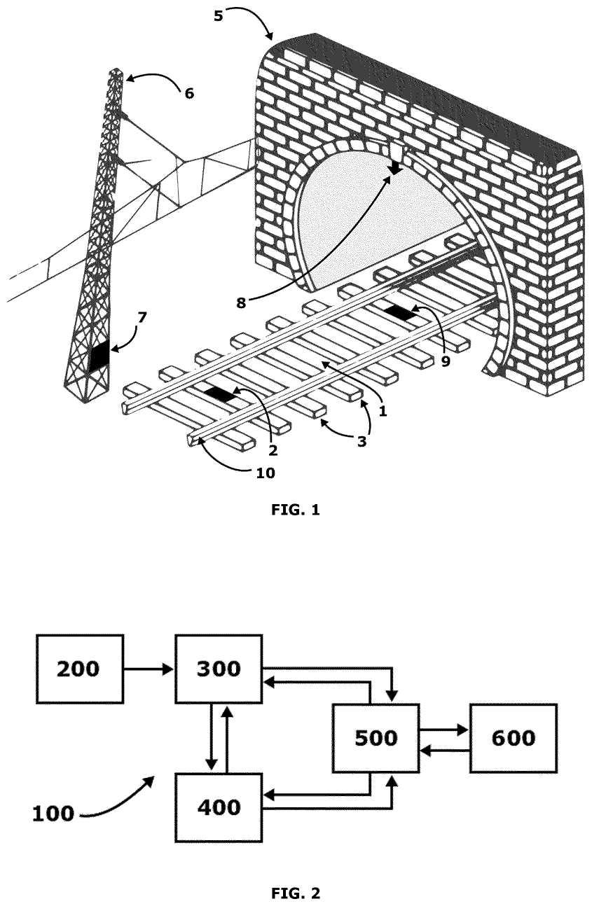

FIG. 1 depicts a schematic representation of a railway network and system arranged at the railway network;

FIG. 2 depicts a system for monitoring a railway network according to embodiments of the present invention;

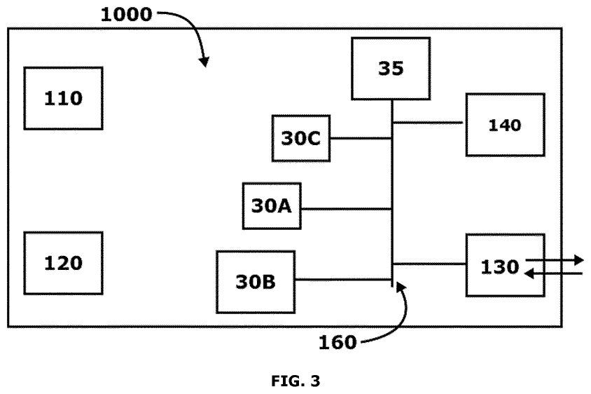

FIG. 3 depicts a schematic of a computing device.

It is noted that not all the drawings carry all the reference signs. Instead, in some of the drawings, some of the reference signs have been omitted for sake of brevity and simplicity of illustration. Embodiments of the present invention will now be described with reference to the accompanying drawings.

FIG. 1 depicts a schematic representation of a railway network and system arranged at the railway network. In simple terms, the system may comprise a railway section with the railway 1 itself, comprising rails 10 and sleepers 3. Instead of the sleepers 3 also a solid bed for the rails 10 can be provided.

Moreover, a further example of constitutional elements is conceptually represented a mast, conceptually identified by reference numeral 6. Such constitutional elements are usually arranged at or in the vicinity of railways. Furthermore, a tunnel is shown, conceptually identified by reference numeral 5. It is needless to say that other constructions, buildings etc. may be present and also used for the present invention as described before and below.

For instance, a first sensor 2 can be arranged on one or more of the sleepers. The sensor 2 can be an acceleration sensor and/or any other kind of railway specific sensor. Examples have been mentioned before.

Further, a second sensor 9 can also arranged on another sleeper distant from the first sensor 2. Although it seems just a small distance in the present example, those distances can range from the distance to the neighboring sleeper to one or more kilometers. Other sensors can be used for attachment to the sleepers as well. The sensors can further be of different kind—such as where the first sensor 2 may be an acceleration sensor, the second sensor 9 can be a magnetic sensor or any other combination suitable for the specific need. The variety of sensors are enumerated before.

Another sensor 7, which may be different or the same kind of sensor, can be attached, for example, to the mast 6 or any other structure. This may be a different kind of sensor, such as, for example, an optical, temperature, even acceleration sensor, etc. A further kind of sensor, for example sensor 8, can be arranged above the railway as at the beginning or within the tunnel 5. This could, for example, be a height sensor for determining the height of a train, an optical sensor, a doppler sensor etc. It will be understood that all those sensors mentioned here and/or before are just non-limiting examples.

Furthermore, the sensors can be configured to submit the sensor data via a communication network, such as a wireless communication network. As the communication network bears several advantages and disadvantages regarding availability, transmittal distance, costs etc. the transmittal of sensor data is optimized as described herein before and below.

FIG. 2 depicts a system 100 monitoring a railway network. In simple terms, the system 100 may comprise a sensor component 200, a processing component 300, a storing component 400, an analyzing component 500 and a server 600.

In one embodiment, the sensor component 200 may comprise a plurality of sensor units, and each may comprise a plurality of sensor nodes. Therefore, the sensor component 200 may also be referred to as a plurality of sensor components 200.

Additionally or alternatively, the sensor component may be configured to sample information relevant to a railway network, for instance, electric current based information of a given component and/part of a railway network.

In one embodiment, the processing 300 component may comprise a standalone component configure to retrieve information from the sensor 200. Additionally or alternatively, the processing component may be configured to bidirectionally communicate the storing component 300 and the analyzing component 500. For instance, the processing component 300 may transfer raw sensor data to the storing component 400, wherein the raw sensor data may be stored until the processing component 300 may require said data for processing to generate a processed sensor data. In another embodiment, the processing component 300 may also transfer processed sensor data to the storing component 400. In a further embodiment, the processing component may also retrieve data from the storing component 400.

In one embodiment, the analyzing component 500 may be configured to bidirectionally communicate with the processing component 300, the storing component 400 and/or the server 600. It will be understood that the communication of the analyzing component 500 with the other components may take place independent and/or simultaneously one from another.

In one embodiment, the processing component 300 may also be integrated with at least one of the sensors 200. In order words, the processing component 300 may also comprise an imbedded module of the sensors 200.

In embodiment, the analyzing component 500 may be configured to process sensor data based on at least one analytical approach, each approach comprising at least one of signal filter processing, pattern recognition, probabilistic modeling, Bayesian schemes, machine learning, supervised learning, unsupervised learning, reinforcement learning, statistical analytics, statistical models, principle component analysis, independent component analysis (ICA), dynamic time warping, maximum likelihood estimates, modeling, estimating, neural network, convolutional network, deep convolutional network, deep learning, ultra-deep learning, genetic algorithms, Markov models, and/or hidden Markov models.

The server 600 may comprise one or more modules configured to receive information from the analyzing component 500.

In another embodiment of the presentation invention, the sensor 200, the processing component 300, the storing component 400 and the analyzing component may comprise an integrated module configured to execute subsequently the tasks corresponding to each individual component, and transfer a final processed analyzed sensor data to the server 600. In simple words, in one embodiment the sensor 200, the processing component 300, the storing component 400 and the analyzing component 500 may comprises modules of a single component.

In one embodiment, the server 600 may retrieve information from the analyzing component 500, and further may provide information to the analyzing component 500, for example, operation parameters. It will be understood that each component may receive a plurality of operation parameters, for instance, the processing component 300 may be commanded to execute a preprocessing of the data received from the sensors 200.

Alternatively or additionally, the processing component 300 may be instructed to transmit the original data received from the sensors 200, i.e. the data coming from the sensors 200 can be transferred directly to the next component without executing any further task. It will be understood that the component may also be configured to perform a plurality of tasks at the same time, e.g. processing the data coming from the sensor 200 before transferring to the next component and transferring the data coming from the sensors 200 without any processing.

In one embodiment, the server 600 may comprise a cloud server, a remote server and/or a collection of different type of servers. Therefore, the server 600 may also be referred to as cloud server 600, remote server 600, or simple as servers 500. In another embodiment, the servers 500 may also converge in a central server.

It will be understood that the server 600 may also be in bidirectional communication with the storing component 400, the processing component or the sensor component 200 without passing through the analyzing component 500 or any other intermediate component. For this purpose, each component may also comprise a remote communication unit configured to establish a remote communication between a component, e.g. sensor component 200, with the server 600.

The storing component 400 may be configured to receive information from the server 600 for storage. In simple words, the storing component 400 may store information provided by the servers 600. The information provided by the server 600 may include, for example, but not limited to, data obtained by sensors 200, data processed by the processing component 500 and any additional data generated in the servers 600. It will be understood that the servers 600 may be granted access to the storing component 400 comprising, inter alia, the following permissions, reading the data allocated in the storing component 400, writing and overwriting the data stored in the storing component 400, control and modify the storage logic and the data distribution within the storing component 400.

In one embodiment of the present invention the server 600 may be configured transmit a signal to other component of the railway system based upon health status information retrieved from sensors 200. For instance, a giving health status data is provided by the server 600 and subsequently the server 600 generates a signal containing instructions, which are transmitted to the railway system for implementation. The set of instructions may comprise, inter alia, generating a hypothesis as regards the health status of the railway network and/or a failure hypothesis, which may comprise instructions to be implemented before a failure occurs on the railway network, such as switching rolling unit from on track to another. Furthermore, the signal may be based on at least one analytical approach, each approach comprising at least one of signal filter processing, pattern recognition, probabilistic modeling, Bayesian schemes, machine learning, supervised learning, unsupervised learning, reinforcement learning, statistical analytics, statistical models, principle component analysis, independent component analysis (ICA), dynamic time warping, maximum likelihood estimates, modeling, estimating, neural network, convolutional network, deep convolutional network, deep learning, ultra-deep learning, genetic algorithms, Markov models, and/or hidden Markov models.

In one embodiment, the sensors 200 may, inter alia, adopt a configuration that allows identifying trains, their speeds and their wear effect on the tracks. The data gathered by the sensors 200 may constitute the basis for the server 600 to generate instructions for the activation of the switches. In simple words, if a train is approaching this part of the network, the sensors 200 may retrieve data that may allow activating the switches in order to redirect the trains, for example, from track 1 to track 2, according to their speed and/or wear effect. The data gathered by the sensors 200 may be communicated to the server 600, which may subsequently transmit the information and the corresponding instructions to the nearest assets, for example, the nearest switch, which may consequently be activated to control the traffic on the tracks. Furthermore, in one embodiment of the present invention, the system 100 may estimate the health status of components of the railway network and may further generate a health status and/or failure hypothesis that may allow to forecast the suitability of the component of the railway network to allocate rolling units. Such hypothesis may be based on at least one analytical approach, each approach comprising at least one of signal filter processing, pattern recognition, probabilistic modeling, Bayesian schemes, machine learning, supervised learning, unsupervised learning, reinforcement learning, statistical analytics, statistical models, principle component analysis, independent component analysis (ICA), dynamic time warping, maximum likelihood estimates, modeling, estimating, neural network, convolutional network, deep convolutional network, deep learning, ultra-deep learning, genetic algorithms, Markov models, and/or hidden Markov models.

In another embodiment of the present invention, the system 100 may determine that a particular part and/or component of the railway network, for instance, a given section of track and/or a switch, is required to be replaced and/or maintain before a given date to avoid failure of the railway.

In one embodiment of the present invention, the system 100 may also determine that a particular rolling stock may pass through a component or portion of the railway network requiring maintenance, reparation or replacement, however, due to work schedule it may be prompt to failure if an inadequate rolling unit passes through. This approach may be advantageous, as it may allow to reduce failure of railway networks, which may be achieved by monitoring, evaluating and forecasting optimal operation conditions of the railway network.

Furthermore, the system 100 may be configured to predict a future status of the railway network and based on that may determine an optimal operation conditions using data analysis based on at least one analytical approach, each approach comprising at least one of signal filter processing, pattern recognition, probabilistic modeling, Bayesian schemes, machine learning, supervised learning, unsupervised learning, reinforcement learning, statistical analytics, statistical models, principle component analysis, independent component analysis (ICA), dynamic time warping, maximum likelihood estimates, modeling, estimating, neural network, convolutional network, deep convolutional network, deep learning, ultra-deep learning, genetic algorithms, Markov models, and/or hidden Markov models.

In more simple words, determinations of the system 100 may directly be used forecast point machine failure, which may be advantageous for planning and execution of maintenance and/or inspections of railway network, which may further allow to minimize downtime of single machines and more importantly an adjacent railway network. Such monitoring, analyzing and forecasting may be based on machine learning comprising predicting health status hypothesis and/or failure hypothesis based on at least one analytical approach, each approach comprising at least one of signal filter processing, pattern recognition, probabilistic modeling, Bayesian schemes, machine learning, supervised learning, unsupervised learning, reinforcement learning, statistical analytics, statistical models, principle component analysis, independent component analysis (ICA), dynamic time warping, maximum likelihood estimates, modeling, estimating, neural network, convolutional network, deep convolutional network, deep learning, ultra-deep learning, genetic algorithms, Markov models, and/or hidden Markov models.

FIG. 3 depicts a schematic of a computing device 1000. The computing device 1000 may comprise a computing unit 35, a first data storage unit 30A, a second data storage unit 30B and a third data storage unit 30C.

The computing device 1000 can be a single computing device or an assembly of computing devices. The computing device 1000 can be locally arranged or remotely, such as a cloud solution.

On the different data storage units 30 the different data can be stored, such as the genetic data on the first data storage 30A, the time stamped data and/or event code data and/or phenotypic data on the second data storage 30B and privacy sensitive data, such as the connection of the before-mentioned data to an individual, on the thirds data storage 30C.

Additional data storage can be also provided and/or the ones mentioned before can be combined at least in part. Another data storage (not shown) can comprise data specifying for instance, air temperature, rail temperature, position of blades, model of point machine, position of point machine and/or further railway network related information. This data can also be provided on one or more of the before-mentioned data storages.

The computing unit 35 can access the first data storage unit 30A, the second data storage unit 30B and the third data storage unit 30C through the internal communication channel 160, which can comprise a bus connection 160.

The computing unit 30 may be single processor or a plurality of processors, and may be, but not limited to, a CPU (central processing unit), GPU (graphical processing unit), DSP (digital signal processor), APU (accelerator processing unit), ASIC (application-specific integrated circuit), ASIP (application-specific instruction-set processor) or FPGA (field programmable gate array). The first data storage unit 30A may be singular or plural, and may be, but not limited to, a volatile or non-volatile memory, such as a random access memory (RAM), Dynamic RAM (DRAM), Synchronous Dynamic RAM (SDRAM), static RAM (SRAM), Flash Memory, Magneto-resistive RAM (MRAM), Ferroelectric RAM (F-RAM), or Parameter RAM (P-RAM).

The second data storage unit 30B may be singular or plural, and may be, but not limited to, a volatile or non-volatile memory, such as a random access memory (RAM), Dynamic RAM (DRAM), Synchronous Dynamic RAM (SDRAM), static RAM (SRAM), Flash Memory, Magneto-resistive RAM (MRAM), Ferroelectric RAM (F-RAM), or Parameter RAM (P-RAM). The third data storage unit 30C may be singular or plural, and may be, but not limited to, a volatile or non-volatile memory, such as a random access memory (RAM), Dynamic RAM (DRAM), Synchronous Dynamic RAM (SDRAM), static RAM (SRAM), Flash Memory, Magneto-resistive RAM (MRAM), Ferroelectric RAM (F-RAM), or Parameter RAM (P-RAM).

It should be understood that generally, the first data storage unit 30A (also referred to as encryption key storage unit 30A), the second data storage unit 30B (also referred to as data share storage unit 30B), and the third data storage unit 30C (also referred to as decryption key storage unit 30C) can also be part of the same memory. That is, only one general data storage unit 30 per device may be provided, which may be configured to store the respective encryption key (such that the section of the data storage unit 30 storing the encryption key may be the encryption key storage unit 30A), the respective data element share (such that the section of the data storage unit 30 storing the data element share may be the data share storage unit 30B), and the respective decryption key (such that the section of the data storage unit 30 storing the decryption key may be the decryption key storage unit 30A).

In some embodiments, the third data storage unit 30C can be a secure memory device 30C, such as, a self-encrypted memory, hardware-based full disk encryption memory and the like which can automatically encrypt all of the stored data. The data can be decrypted from the memory component only upon successful authentication of the party requiring to access the third data storage unit 30C, wherein the party can be a user, computing device, processing unit and the like. In some embodiments, the third data storage unit 30C can only be connected to the computing unit 35 and the computing unit 35 can be configured to never output the data received from the third data storage unit 30C. This can ensure a secure storing and handling of the encryption key (i.e. private key) stored in the third data storage unit 30C.

In some embodiments, the second data storage unit 30B may not be provided but instead the computing device 1000 can be configured to receive a corresponding encrypted share from the database 60. In some embodiments, the computing device 1000 may comprise the second data storage unit 30B and can be configured to receive a corresponding encrypted share from the database 60.

The computing device 1000 may comprise a further memory component 140 which may be singular or plural, and may be, but not limited to, a volatile or non-volatile memory, such as a random access memory (RAM), Dynamic RAM (DRAM), Synchronous Dynamic RAM (SDRAM), static RAM (SRAM), Flash Memory, Magneto-resistive RAM (MRAM), Ferroelectric RAM (F-RAM), or Parameter RAM (P-RAM). The memory component 140 may also be connected with the other components of the computing device 1000 (such as the computing component 35) through the internal communication channel 160.

Further the computing device 1000 may comprise an external communication component 130. The external communication component 130 can be configured to facilitate sending and/or receiving data to/from an external device (e.g. backup device 10, recovery device 20, database 60). The external communication component 130 may comprise an antenna (e.g. WIFI antenna, NFC antenna, 2G/3G/4G/5G antenna and the like), USB port/plug, LAN port/plug, contact pads offering electrical connectivity and the like. The external communication component 130 can send and/or receive data based on a communication protocol which can comprise instructions for sending and/or receiving data. Said instructions can be stored in the memory component 140 and can be executed by the computing unit 35 and/or external communication component 130. The external communication component 130 can be connected to the internal communication component 160. Thus, data received by the external communication component 130 can be provided to the memory component 140, computing unit 35, first data storage unit 30A and/or second data storage unit 30B and/or third data storage unit 30C. Similarly, data stored on the memory component 140, first data storage unit 30A and/or second data storage unit 30B and/or third data storage unit 30C and/or data generated by the commuting unit 35 can be provided to the external communication component 130 for being transmitted to an external device.

In addition, the computing device 1000 may comprise an input user interface 110 which can allow the user of the computing device 1000 to provide at least one input (e.g. instruction) to the computing device 100. For example, the input user interface 110 may comprise a button, keyboard, trackpad, mouse, touchscreen, joystick and the like.

Additionally, still, the computing device 1000 may comprise an output user interface 120 which can allow the computing device 1000 to provide indications to the user. For example, the output user interface 110 may be a LED, a display, a speaker and the like.

The output and the input user interface 100 may also be connected through the internal communication component 160 with the internal component of the device 100.

The processor may be singular or plural, and may be, but not limited to, a CPU, GPU, DSP, APU, or FPGA. The memory may be singular or plural, and may be, but not limited to, being volatile or non-volatile, such an SDRAM, DRAM, SRAM, Flash Memory, MRAM, F-RAM, or P-RAM.

The data processing device can comprise means of data processing, such as, processor units, hardware accelerators and/or microcontrollers. The data processing device 20 can comprise memory components, such as, main memory (e.g. RAM), cache memory (e.g. SRAM) and/or secondary memory (e.g. HDD, SDD). The data processing device can comprise busses configured to facilitate data exchange between components of the data processing device, such as, the communication between the memory components and the processing components. The data processing device can comprise network interface cards that can be configured to connect the data processing device to a network, such as, to the Internet. The data processing device can comprise user interfaces, such as:
output user interface, such as:
   screens or monitors configured to display visual data (e.g. displaying graphical user interfaces of railway network status),
   speakers configured to communicate audio data (e.g. playing audio data to the user),
input user interface, such as:
   camera configured to capture visual data (e.g. capturing images and/or videos of the user),
   microphone configured to capture audio data (e.g. recording audio from the user),
   keyboard configured to allow the insertion of text and/or other keyboard commands (e.g. allowing the user to enter text data and/or other keyboard commands by having the user type on the keyboard) and/or trackpad, mouse, touchscreen, joystick—configured to facilitate the navigation through different graphical user interfaces of the questionnaire.

The data processing device can be a processing unit configured to carry out instructions of a program. The data processing device can be a system-on-chip comprising processing units, memory components and busses. The data processing device can be a personal computer, a laptop, a pocket computer, a smartphone, a tablet computer. The data processing device can be a server, either local and/or remote. The data processing device can be a processing unit or a system-on-chip that can be interfaced with a personal computer, a laptop, a pocket computer, a smartphone, a tablet computer and/or user interface (such as the upper-mentioned user interfaces).

While in the above, a preferred embodiment has been described with reference to the accompanying drawings, the skilled person will understand that this embodiment was provided for illustrative purpose only and should by no means be construed to limit the scope of the present invention, which is defined by the claims.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

1. A system for monitoring a railway network, the system comprising:
at least one sensor component configured to sample sensor data relevant to the railway network,
at least one processing component configured to process the sensor data,
at least one storing component configured to store the sensor data relevant to the railway network and the processed sensor data,
at least one analyzing component, and
at least one server.

2. The system according to claim 1, wherein the at least one analyzing component is configured to at least one of:
receive the sensor data from the at least one sensor component,
monitor at least one railway health status of at least one component of the railway network,
forecast at least one railway health status of at least one component of the railway network, and/or
generate at least one railway health status hypothesis comprising at least one cause for the at least one railway health status of the at least one component of the railway network.

3. The system according to claim 1, wherein the sensor data relevant to the railway network comprises at least one railway infrastructural feature, wherein the at least one railway infrastructural feature comprises at least one feature based on electric current (EC) records.

4. The system according to claim 1, wherein the at least one analyzing component comprises a self-learning module configured to at least one of:
analyze the at least one infrastructural feature,
determine changes of the at least one infrastructural feature over time, and/or
correlate changes of the at least one infrastructural feature with at least one railway health status hypothesis.

5. The system according to claim 4, wherein self-learning module, in the step of correlating changes of the last one infrastructural feature with at least one railway health status hypothesis, is further configured to execute at least one simulation model.

6. The system according to claim 1, wherein the at least one analyzing component is configured to execute at least one analytical approach and at least one server configured to at least one of:
receive sensor data relevant to the railway network,
monitor the sensor data, and/or
generate an optimizing routing of rolling stocks on the railway network based on sensor data related to the railway network,
wherein the at least one server is configured to generate an optimizing routing of rolling stocks by means of the least one analytical approach.

7. A method for monitoring a railway network, the method comprising the steps of
retrieving at least one point machine data;
processing the least one point machine data to generate at least one processed point machine data; and
generating at least one railway health hypothesis based on the at least one processed point machine data.

8. The method according to claim 7, further comprising the step of forecasting at least one railway health status of at least one component of the railway network based on the at least one railway health hypothesis.

9. The method according to claim 8, wherein the step of forecasting at least one railway health status of the at least one component the railway network comprises using trends in at least one feature based on electric current (EC) records.

10. The method according to claim 7, wherein the method comprises the step of generating at least one railway failure hypothesis, wherein the at least one railway failure hypothesis is based on the at least one railway health hypothesis, and wherein the at least one railway failure hypothesis is based on the at least one processed point machine data.

11. The method according to claim 10, further comprising the step of forecasting at least one railway failure of at least one component of the railway network based on the at least one railway failure hypothesis, wherein the method further comprises using at least one feature based on at least one transformation of traces comprising at least one of:
functional principal component analysis scores,
reductions of wavelet transformation, and/or
deviations from at least one average curve.

12. The method according to claim 7, further comprising the step of
calculating at least one feature based on at least one complete trace based on at least one specific part of at least one trace,
splitting the at least one trace into at least one time interval comprising equal-length time intervals,
splitting the least one trace into at least one phase comprising at least one of
a ramp-up phase,
an unlocking phase.
a moving phase, wherein the moving phase comprises at least one of moving a first blade, and/or
moving a second blade.
locking phase.

13. The method according to claim 8, wherein the step of forecasting at least one railway health status of the at least one component the railway network comprises using trends in at least one feature not based on electric current (EC) records comprising at least one of:
air temperature,
rail temperature,
position of blades,
model of point machine, and/or
position of point machine.

14. The method according to claim 13, further comprising the step of generating at least one hypothesis as regards the position of blades, wherein the method comprises
outputting a first finding comprising a first position of the blades,
outputting a second finding comprising a second position of the blades,
contrasting the first finding with the second finding, and/or
generating a cause for the difference between the first finding and second finding, wherein the first position of the blades is a left locking position and the second position of the blades is a right blocking position.

15. The method according to claim 8, wherein the step of forecasting at least one railway health status of the least one component of the railway network is based on at least one analytical approach, and wherein the method further comprises the step of retrieving a first data of a first occurrence of a feature,
processing the first data of the first occurrence of the feature,
retrieving a n-th data of a n-th occurrence of the feature,
processing the n-th data of the n-th occurrence of the feature,
generating a data difference finding, wherein the data difference finding is based on at least one parameter difference between the first data of the first occurrence and the n-th data of the n-th occurrence, and
outputting an interpreted data difference finding.
